(19) United States
(12) Patent Application Publication
(10) Pub. No.: US 2026/0299520 A1
(43) Pub. Date: Oct. 1, 2026

(54) WATCH HOUSING HAVING A RECEIVING STRUCTURE AND OUTER STRUCTURE ELEMENTS

(71) Applicant: Garmin International, Inc., Olathe, KS (US)

(72) Inventors: Anup N. Kulkarni, Olathe, KS (US); Tyler J. Sharp, Olathe, KS (US); Nolan J. Stengel, Olathe, KS (US); Surajit Bhaduri, Olathe, KS (US); Andrew C. Murray, Olathe, KS (US); Cody J. Barthuly, Olathe, KS (US)

(21) Appl. No.: 19/278,514

(22) Filed: Jul. 23, 2025

Related U.S. Application Data
(60) Provisional application No. 63/777,384, filed on Mar. 25, 2025.

(51) Int. Cl. G04B 29/02; G04B 29/04; G04B 45/00

(52) U.S. Cl. CPC G04B 29/027; G04B 29/04; G04B 45/0015

(57) ABSTRACT

A wrist-worn electronic device comprises an upper housing and a lower housing. The upper housing includes a bezel formed from electrically conductive material. The lower housing includes a receiving structure and at least two outer structure elements. The receiving structure is formed from electrically non-conductive material and includes a bottom wall and one or more side walls connected to the bottom wall. The one or more side walls have within an outer surface thereof a first recess and a second recess that is positioned opposing the first recess. The at least two outer structure elements are formed from electrically conductive material. Each outer structure element is positioned in and secured to a respective one of the first recess or the second recess. Each outer structure element has two ends that each form a lug of the electronic device between which a wrist band pin is secured.

### RELATED APPLICATIONS

The current patent application is a non-provisional utility patent application which claims priority benefit, with regard to all common subject matter, under 35 U.S.C. § 119(e) of earlier-filed U.S. Provisional Application Ser. No. 63/777,384, filed Mar. 25, 2025, and entitled “WATCH HOUSING HAVING A RECEIVING STRUCTURE AND OUTER STRUCTURE ELEMENTS.” The Provisional Application is hereby incorporated by reference, in its entirety, into the current patent application.

### BACKGROUND

A wearable electronic device, such as a wrist-worn smart watch, typically include one or more antennas to receive global navigation satellite system (GNSS) signals and provide communication with other devices or telecommunications networks. The housing of the device, which retains the antennas, is often formed from electrically non-conductive material, such as plastic, to avoid causing any interference or disruption of the operation of the antennas. However, consumers have shown a desire for the housing to be formed from electrically conductive material, namely metal, for its aesthetic qualities.

### SUMMARY

Embodiments of the present technology provide a wrist-worn electronic device that includes a housing with a bottom wall and a single side wall that are formed from non-metallic materials, such as polymers (plastics), glass, or the like and at least two outer structural elements which are formed from an electrically conductive material and are positioned in and secured to opposing sides of the side wall—giving the electronic device the appearance of being mostly metal as a substantial portion of the external surfaces that are visible when worn on a wrist of a user are formed of the electrically conductive material, such as metal. The electronic device broadly comprises an upper housing and a lower housing. The upper housing includes a bezel formed from electrically conductive material. The lower housing includes a receiving structure and at least two outer structure elements. The receiving structure is formed from electrically non-conductive material and includes a bottom wall and one or more side walls connected to the bottom wall. The one or more side walls have within an outer surface thereof a first recess and a second recess positioned opposing the first recess. The at least two outer structure elements are formed from electrically conductive material. Each outer structure element is positioned in and secured to a respective one of the first recess or the second recess.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF DRAWINGS

Embodiments of the present technology are described in detail below with reference to the attached drawing figures, wherein:

FIG. 1A is an upper perspective view of a wrist-worn electronic device, constructed in accordance with various embodiments of the current technology, including a housing that has a receiving structure formed from electrically non-conductive materials and outer structural elements formed from electrically conductive materials and which overlay the receiving structure;

FIG. 1B is a lower perspective of the electronic device;

FIG. 2 is a schematic block diagram of various components of the electronic device;

FIG. 3 is a top plan view of the electronic device;

FIG. 4 is a partially exploded top plan view of the electronic device;

FIG. 5 is a partially exploded upper perspective view of the electronic device;

FIG. 6A is a first side view of the electronic device;

FIG. 6B is the first side view of the electronic device with the outer structural elements removed from the receiving structure;

FIG. 7A is a second side view of the electronic device;

FIG. 7B is the second side view of the electronic device with the outer structural elements removed from the receiving structure;

FIG. 8 is a first end view of the electronic device;

FIG. 9 is a second end view of the electronic device;

FIG. 10 is the first end view of the electronic device with a display removed from an upper portion of the housing;

FIG. 11 is the top plan view of the electronic device illustrating portions of a circumference of the electronic device occupied by a communication slot antenna and a global navigation satellite system (GNSS) slot antenna;

FIG. 12 is the top plan view of the electronic device illustrating portions of a circumference of the electronic device occupied by a communication loop antenna and a GNSS loop antenna;

FIG. 13 is a top plan view of a second embodiment of the electronic device which includes an extended glass display cover and no bezel; and

FIG. 14 a sectional top plan view of the second embodiment of the electronic device cut along a horizontal plane and illustrating a first signal path for a communication loop antenna and a second signal path for a GNSS loop antenna.

The drawing figures do not limit the present technology to the specific embodiments disclosed and described herein. The drawings are not necessarily to scale, emphasis instead being placed upon clearly illustrating the principles of the technology.

### DETAILED DESCRIPTION OF THE TECHNOLOGY

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

Relational and/or directional terms, such as “above”, “below”, “up”, “upper”, “upward”, “down”, “lower”, “downward”, “top”, “bottom”, “outer”, “inner”, “left”, “right”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology in practice may be positioned and oriented in other ways or move in other directions. Therefore, the terms do not limit the scope of the current technology.

Embodiments of the present technology relate to an electronic device that can be worn on a user's wrist and that wirelessly communicates with other devices, systems, and networks. The electronic device may be a fitness watch, a wrist-worn smart phone, a wrist-worn navigation device, or other wearable multi-function electronic devices that include a housing and a wrist band, strap, or other attachment mechanism to secure the electronic device to a wrist or other extremity of the user. Some users prefer the appearance, or aesthetic form, of a watch having a housing that is formed entirely or mostly of metal—specifically, the bezel (surrounding a central display of the watch) and one or more side walls of the watch being formed of metal. To many users, a metal housing gives a watch a more desirable appearance of luxury and use of premium materials as a watch having a metal housing is typically more expensive and challenging to produce than a watch having a non-metal housing. Some users may desire the weight of the metal housing of such watches as watches having metal housings are typically heavier than non-metal housings. As the use of a metal housing may present challenges to manufacture a watch, those challenges are compounded for watches configured to wirelessly transmit or receive electronic signals. Usually, metal components, such as the housing walls, have to be formed using subtractive manufacturing techniques, which is commonly a less efficient process as the minimal tolerances for the housing walls may result in increased disposal or recycling of non-compliant components during the manufacturing process. Furthermore, the one or more side walls and a bottom wall have openings to allow for pushbuttons, dials, crowns, or other user interface components, as well as battery charging or electronic communication cables, heart rate monitoring optical devices, and the like. Given the small scale of the housing and the size each opening in such a housing, it is challenge to produce such housings precisely and carefully. In addition, the bottom wall and the one or more side walls are typically separate pieces, which require further assembly to connect to one another to form a lower portion of an inner cavity of the housing.

The electronic device of the present technology includes a housing with a bottom wall and a single side wall that are formed from non-metallic materials, such as polymers (plastics), glass, or the like. In embodiments, the bottom wall and the side wall may be formed as a monolithic (single) unit using techniques such as injection molding or 3D printing, which may provide greater manufacturing efficiency and lead to a lower cost of production. In order to provide a desirable aesthetic, the electronic device includes a metal bezel as well as metallic outer structural elements positioned on opposing sides of the side wall—giving the electronic device the appearance of being mostly metal as a substantial portion of the external surfaces that are visible when worn on a wrist of a user are formed of metal.

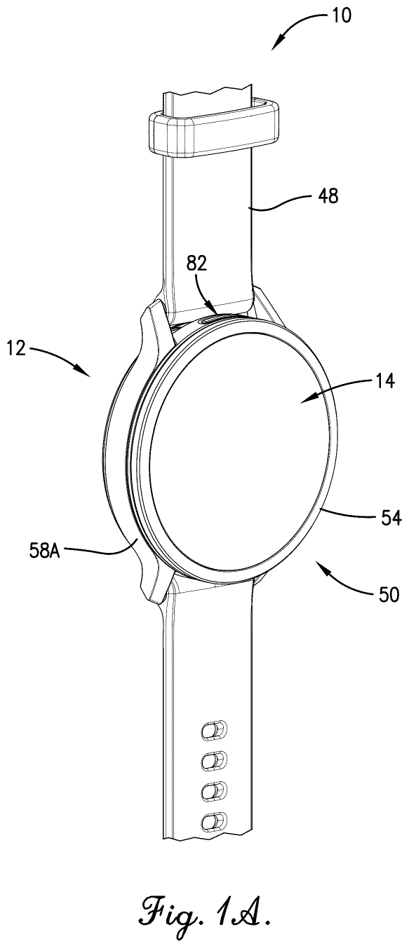

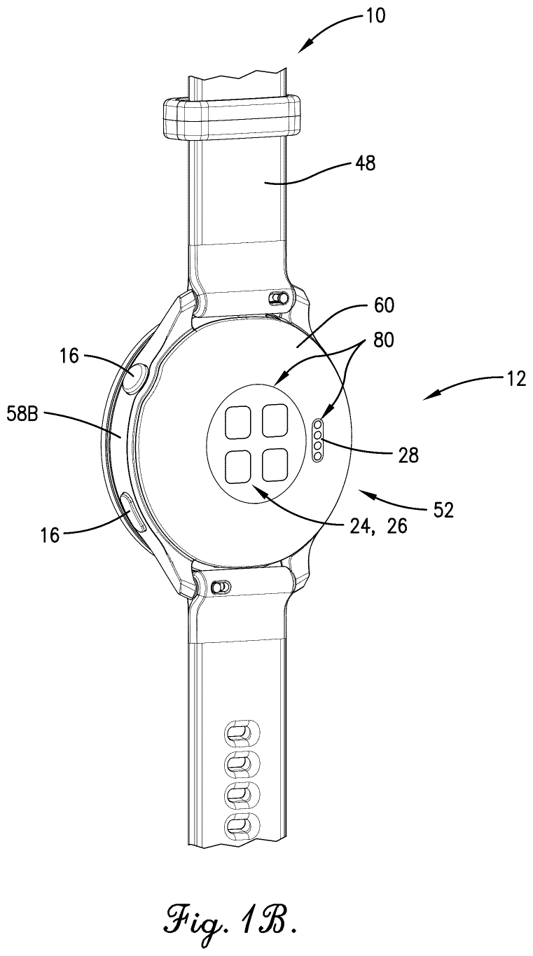

Embodiments of the technology will now be described in more detail with reference to the drawing figures. Referring initially to FIGS. 1A-1B and 2, a wrist-worn electronic device 10 is illustrated. The electronic device 10 broadly comprises a housing 12, a display 14, a user interface 16, a barometric pressure measuring device 18, a flashlight 20, a microphone 22, a plurality of optical transmitters 24A, a plurality of optical receivers 24B, a speaker 26, an electrical interface 28, a memory element 30, a processor 32, a location determining element 34, a communication element 36, a global navigation satellite system (GNSS) slot antenna 40, a communication slot antenna 42, a GNSS loop antenna 44, and a communication loop antenna 46. The electronic device 10 may also include a wrist band 48, a strap, or other attachment mechanisms.

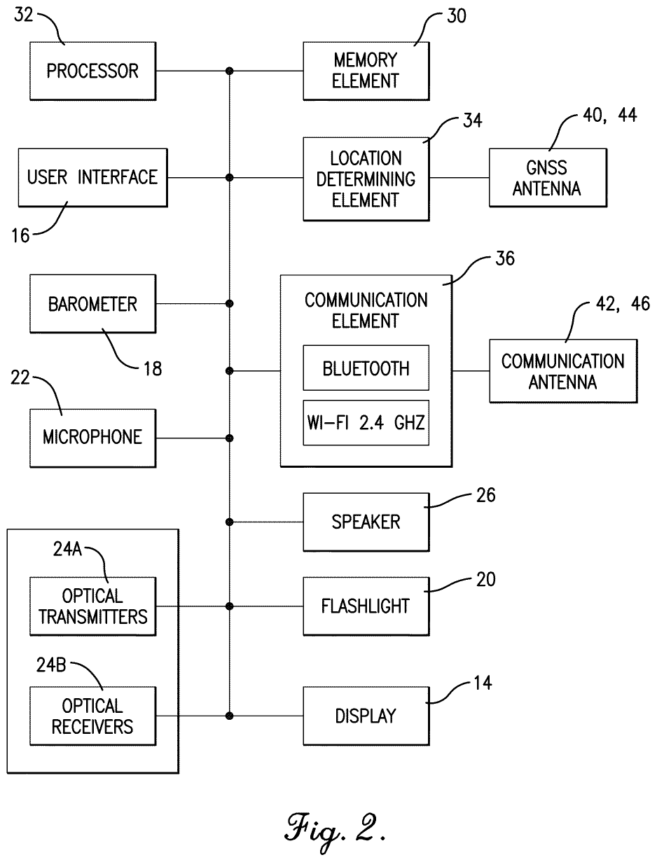

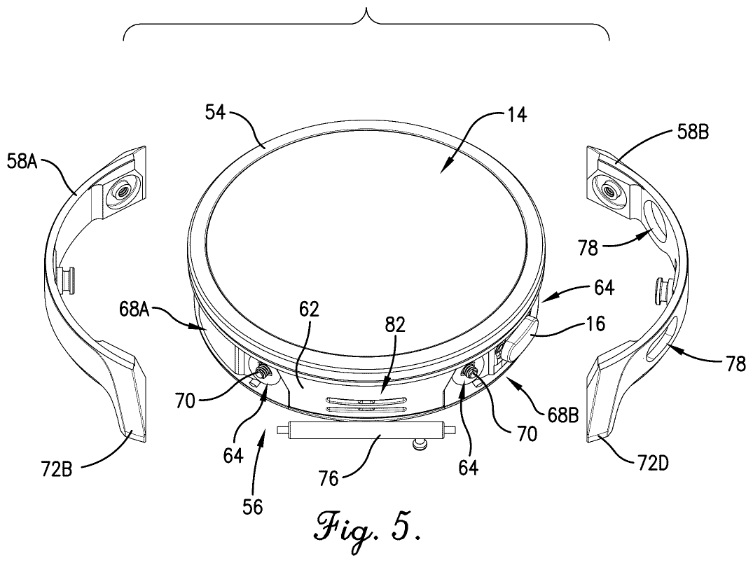

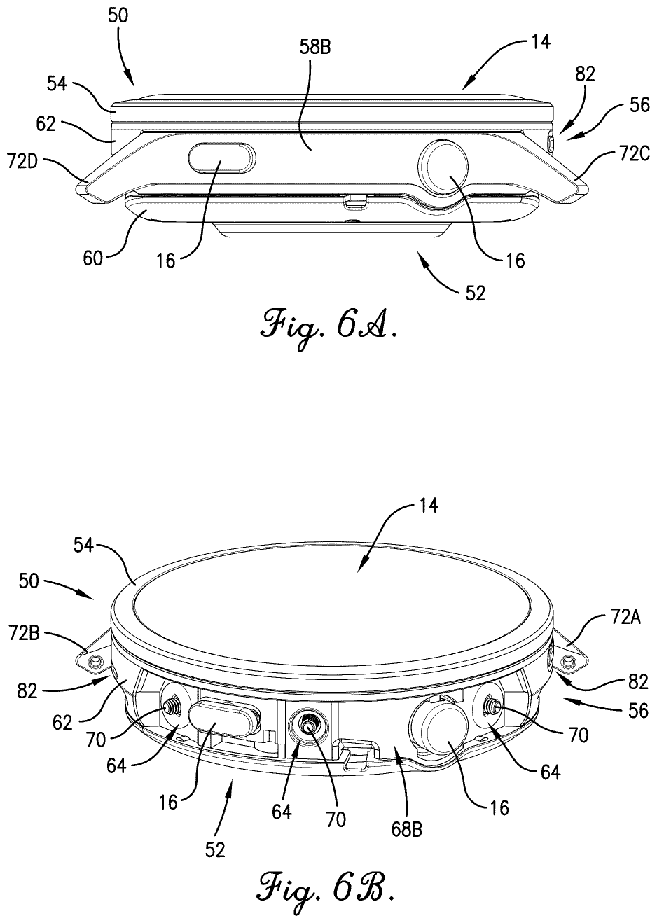

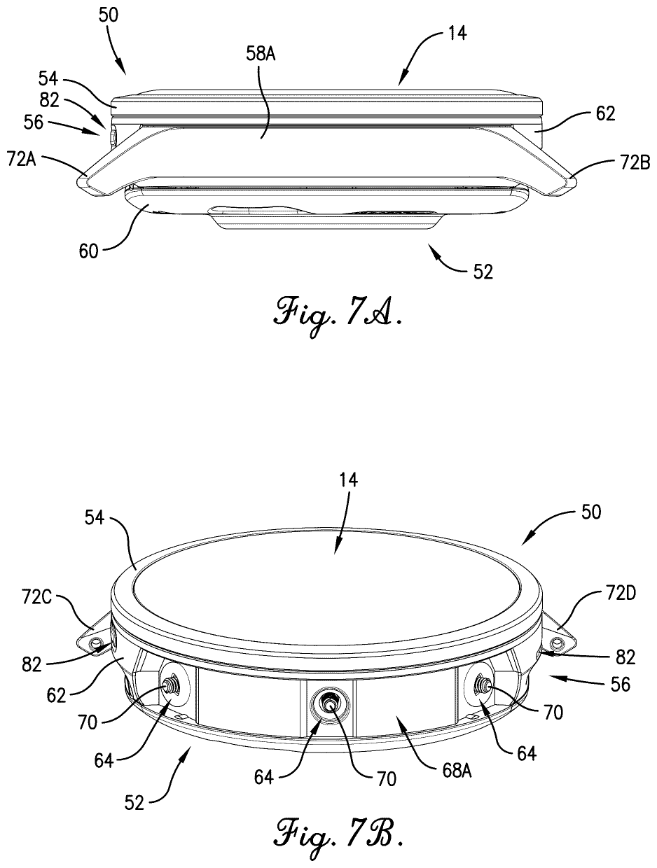

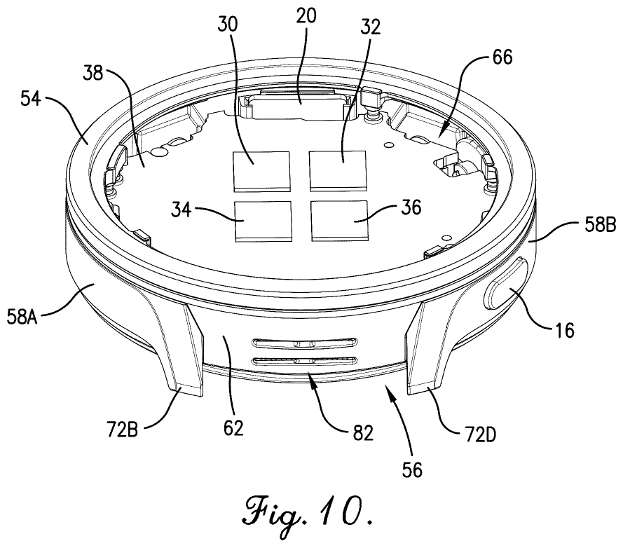

Referring to FIGS. 3-10, the housing 12 includes an upper housing 50 and a lower housing 52. The upper housing 50 includes a bezel 54 which is formed from an electrically conductive material, such as metals or metal alloys. A shape of the bezel 54 varies according to, or corresponds to, a shape of a perimeter of the housing 12. In exemplary embodiments shown in the figures, the shape of the perimeter of the housing 12 is circular, so the bezel 54 has a general ring, or annular, shape which includes a central opening within which the display 14 is positioned.

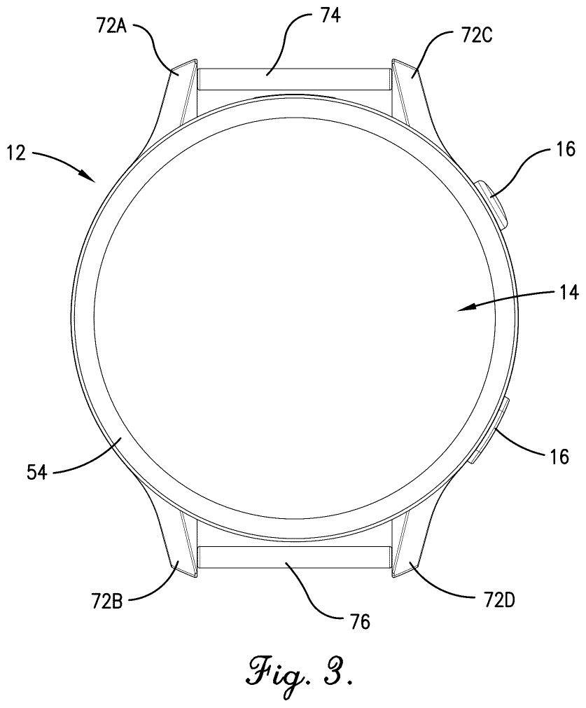

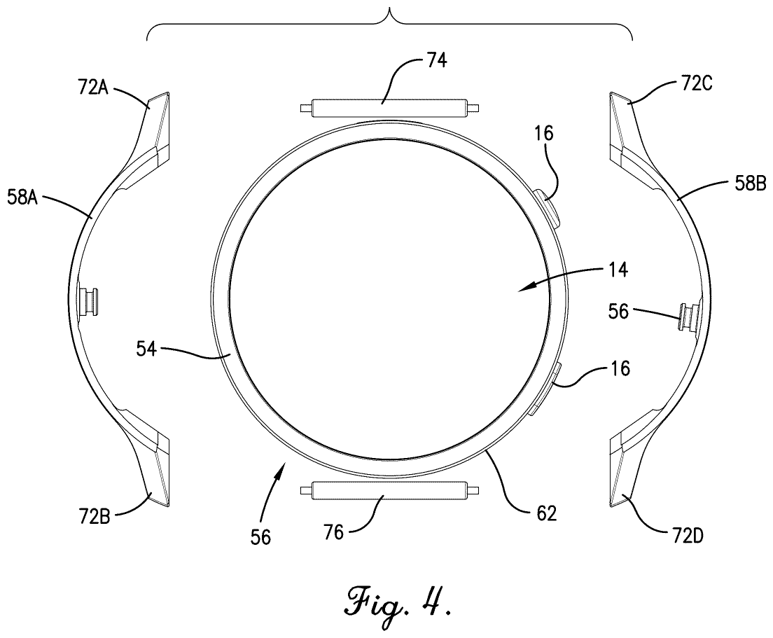

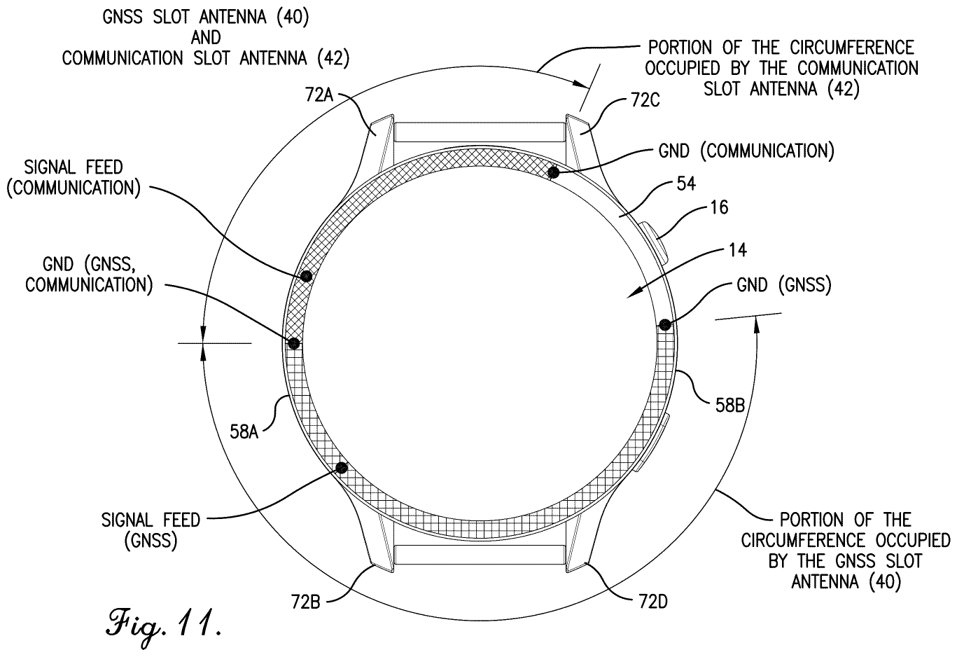

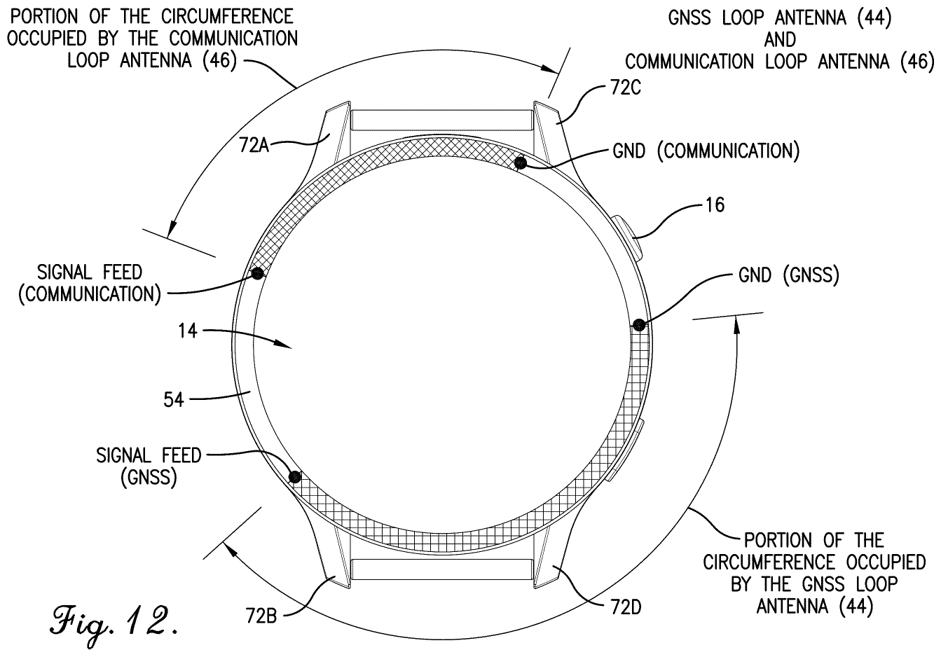

The lower housing 52 includes a receiving structure 56 and a plurality of outer structural elements 58. The receiving structure 56 is formed of an electrically non-conductive, or insulating, material, such as plastic, polymers, glass, or the like. The receiving structure 56 includes a bottom wall 60 and one or more side walls 62 connected to the bottom wall 60. The bottom wall 60 is generally disc shaped and, in some embodiments, may be formed from electrically conductive material, such as metals or metal alloys. In exemplary embodiments shown in the figures, the receiving structure 56 includes a single, generally cylindrical side wall 62 connected to the circumference of the bottom wall 60. The inner surfaces of the upper housing 50 and the lower housing 52 define the boundaries of an internal cavity 66 in which a printed circuit board 38 and many of the components of the electronic device 10 are retained. In embodiments, the housing 12 includes a plurality of electrical connections between an electrical ground of the printed circuit board 38 and the outer structural elements 58. As shown in FIGS. 4 and 5, each receiving structure 56 of the outer structural elements 58 forms an electrical connection to the electrical ground of the printed circuit board 38. For example, the receiving structure 56 and other electrically conductive elements of the housing 12 electrically ground the outer structure elements 58 in embodiments utilizing the GNSS slot antenna 40 and the communication slot antenna 42, as shown in FIG. 11. Similarly, the receiving structure 56 and other electrically conductive elements of the housing 12 electrically ground the outer structure elements 58 in embodiments utilizing the GNSS loop antenna 44 and the communication loop antenna 46, as shown in FIG. 12.

The side wall 62 further includes a plurality of recesses 68 that are inset in an outer surface thereof. In exemplary embodiments shown in the figures, the side wall 62 includes a first recess 68A and a second recess 68B, the second recess 68B at a position opposing the first recess 68A. Each recess 68 has an upper boundary and a lower boundary along a vertical dimension of the side wall 62. That is, the upper boundary of each recess 68 is below an upper edge of the side wall 62, and the lower boundary of each recess 68 is above a lower edge of the side wall 62. In addition, each recess 68 has a first end point and a second end point along a circumference of the side wall 62, such that each recess 68 extends along a respective portion of the circumference of the side wall 62. For example, the first recess 68A may extend along a first portion of the circumference between approximately 11:00 and approximately 7:00 relative to a watch face. The second recess 68B may extend along a second portion of the circumference between approximately 1:00 and approximately 5:00 relative to a watch face.

Each outer structural element 58 is formed of electrically conductive materials, such as metals or metal alloys and is positioned within a respective one of the recesses 68. Thus, in exemplary embodiments shown in the figures, a central portion of a first outer structural element 58A is positioned within and secured to the first recess 68A, and a central portion of a second outer structural element 58B is positioned within and secured to the second recess 68B. Each outer structural element 58 is generally elongated and includes a central section, a first end, and a spaced apart, opposing second end. The central section includes one or more fastening or attachment element(s), such as threaded openings within an inner surface that are utilized to secure and attach each outer structural element 58 to the side wall 62. The electronic device 10 may also include a plurality of fasteners 70 or attachment components, such as threaded screws, which are tightened to fasten and secure each outer structural element 58 to the side wall 62.

The first end and the second end of each outer structural element 58 extend outward from the side wall 62 and form one of a plurality of lugs 72. For example, a first end of the first outer structural element 58A forms a first lug 72A, and a second end of the first outer structural element 58A forms a second lug 72B. Similarly, a first end of the second outer structural element 58B forms a third lug 72C, and a second end of the second outer structural element 58B forms a fourth lug 72D. Each lug 72 includes a cavity on an inner surface thereof. The first lug 72A and the third lug 72C are positioned proximate to a 12:00 position relative to a watch face and retain a first wrist band pin 74 that partially extends into and is secured in the cavities of the first lug 72A and the third lug 72C. The second lug 72B and the fourth lug 72D are positioned proximate to a 6:00 position relative to a watch face and retain a second wrist band pin 76 that partially extends into and is secured in the cavities of the second lug 72B and the fourth lug 72D.

The recesses 68 are positioned on the side wall 62 such that the upper surface of each outer structure element 58, once secured in its respective recess 68, is spaced apart (vertically separated) from a lower surface of the bezel 54 by a separation distance. This separation distance isolates portions of the bezel 54 that at least partially forms an antenna from portion(s) of each outer structure element 58 that at least partially form an antenna.

The side wall 62 may include a plurality of openings around which an o-ring 64 is positioned and one or more through holes 82. As shown in FIGS. 5, 6B and 7B, each o-ring 64 may enclose a fastener 70, such as a threaded screw that is tightened to fasten and secure each outer structural element 58 to the side wall 62 and position each outer structural element 58 within a respective one of the recesses 68. As shown in FIG. 5, each o-ring 64 may have a shape or thickness that corresponds to a shape or depth of an opening or channel around a receive-side element of the outer structural element 58 to which the fastener 70 couples.

The display 14 may include video devices of the following types: plasma, light-emitting diode (LED), organic LED (OLED), Light Emitting Polymer (LEP) or Polymer LED (PLED), liquid crystal display (LCD), thin film transistor (TFT) LCD, LED side-lit or back-lit LCD, or the like, or combinations thereof. The display 14 may include a screen on which information is presented, with the screen possessing any one of a variety of shapes, such as a square or a rectangular aspect ratio that may be viewed in either a landscape or a portrait mode. In some embodiments, the display 14 may further include a lens and other components overlying the viewing area, which may enhance the visibility of the information shown on the display 14. In various embodiments, the display 14 may also include a touch screen occupying the entire screen or a portion thereof so that the display 14 functions as part of the user interface 16. The touch screen may allow the user to interact with the electronic device 10 by physically touching, swiping, or gesturing on areas of the screen. The display 14 may be in electronic communication with the memory element 30 and the processor 32 and may receive data or information therefrom that is to be shown on the display 14. In exemplary embodiments, the display 14 is generally surrounded by the bezel 54.

The user interface 16 generally allows the user to directly interact with the electronic device 10 and may include components such as pushbuttons, rotary knobs, or the like. In exemplary embodiments of FIGS. 3-9, the housing 12 may include one or more pushbuttons and/or rotary knobs located in the through holes of the side wall 62 that function as at least a portion of the user interface 16. In addition, one or both of the outer structural elements 58 may include openings 78 from the inner surface to the outer surface through which the components of the user interface 16 are positioned and accessed. The user interface 16 may allow the user to scroll through menus or change screens in order to control the function or operation of the electronic device 10.

The barometric pressure measuring device 18 (barometer) is configured to measure an atmospheric pressure of the air in the vicinity of the electronic device 10. The barometric pressure measuring device 18 may include components such as microelectromechanical systems (MEMS) devices. The barometric pressure measuring device 18 may be positioned in the internal cavity 66 in proximity to one of the through holes 82 of the side wall 62 of the housing 12 so as to receive atmospheric air flow.

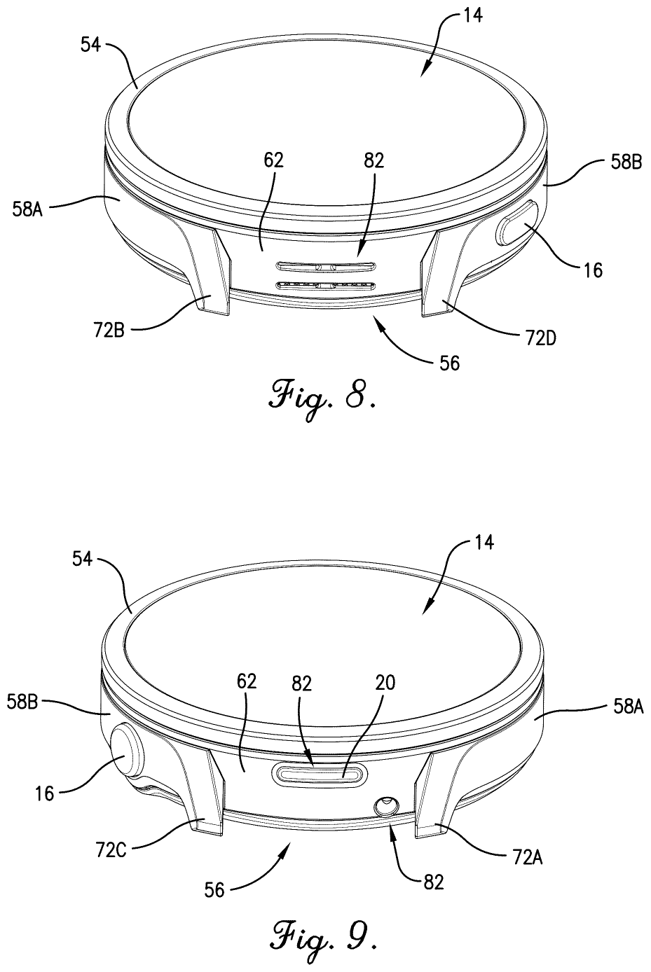

The flashlight 20 is configured to emit visible light and may include one or more light emitting devices (LEDs). The flashlight 20 may be positioned in the internal cavity 66 in proximity to one of the through holes 82 of the side wall 62 of the housing 12 such that the visible light emitted by flashlight 20 may pass light through the through hole 82. For instance, the microphone 22 may be positioned in an oval or pill-shaped through hole 82 that exists between two lugs, such as the first lug 72A and the third lug 72C, and is enclosed by a transparent or semi-transparent lens cover, as shown in FIG. 9.

The microphone 22 is configured to receive audible speech or acoustic (sound) signals and convert the received sound to a corresponding electronic signal. The microphone 22 may include one or more transducers or the like which convert the audible speech or acoustic signals to an electronic signal. The microphone 22 may be positioned in the internal cavity 66 in proximity to one of the through hole 82 of the side wall 62 of the housing 12 such that the microphone 22 receives sound from outside the electronic device 10. For instance, the microphone 22 may be positioned in a small circular through hole 82 that exists between two lugs, such as the first lug 72A and the third lug 72C, as shown in FIG. 9. When the electronic device 10 is worn by a user on a wrist, the microphone 22 may more clearly receive audible speech inputs if the user lifts his or her wrist in an upward direction towards his or her mouth.

The optical transmitters 24A in combination with the optical receivers 24B are configured to transmit optical signals (light) into the skin of the user's wrist and receive reflections of the optical signals from the user's wrist in order to determine physiological information about the user, such as a heart rate, pulse oximetry, and the like. Each optical transmitter 24A includes a light emitting diode (LED) that is configured to receive an electronic signal (typically of varying electric current) and output (emit) an optical signal in the visible and/or infrared spectrum from an opening a bottom surface of bottom wall 60 into the user's wrist. The LED output one or more optical signals having a wavelength in the visible light spectrum, which is typically between approximately 400 nanometers (nm) to 700 nm, in the near infrared spectrum, which is typically between approximately 700 nm to 1,000 nm, and/or in a wavelength range of 1,000 nm to 1,500 nm. For instance, optical signals having a wavelength between 500 nm and 600 nm are associated with visually appearing as the color green.

Each optical receiver 24B includes a photodiode that is configured to receive reflections of the optical signal from the user's skin and output an electric current that corresponds to (varies according to) the intensity of the received optical signal over time. Specifically, the optical receiver 24B outputs a electronic signal having an amplitude and a frequency that varies according to the amplitude and frequency of the received optical signal.

The optical transmitters 24A and the optical receivers 24B may be positioned in the internal cavity 66 in proximity to a central opening 80 in the bottom wall 60, shown in FIG. 1B, such that the optical signals are output through the central opening 80 and reflections of the optical signals are received through the central opening 80.

The speaker 26 may be a mid-range or tweeter secured or mounted in the inner cavity 66 proximate to one of the through holes 82 in the side wall 62 of the housing 12 such that the speaker 26 outputs sound outside the electronic device 10. The speaker 26 may include a diaphragm and protective cap. The speaker 26 may be formed of a material that is resistant to moisture, debris and other contaminants that may be present in an outdoor environment. The through hole 82 may be located at approximately 6:00 relative to the watch face and perforated to allow sound generated by speaker 26 to pass outside the inner cavity for reception by the user or others. For instance, the speaker 26 may be positioned in an oval through hole 82 that exists between two lugs, such as the second lug 72B and the fourth lug 72D.

The electrical interface 28 is configured to provide electrical connectivity to a battery (not shown in the figures) as well as the memory element 30, the processor 32, and other electronic components. The electrical interface 28 may be utilized to charge the battery and provide information and/or data to the electronic device 10 such as firmware updates and the like. The electrical interface 28 may be positioned in the internal cavity 66 and accessed through one of the openings 3A on the bottom wall 60, shown in FIG. 1B. The electrical interface 28 may include a receptacle configured to receive a connector coupled to an electrically conductive cable.

The memory element 30 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, optical disks, flash memory, thumb drives, universal serial bus (USB) drives, solid state memory, solid state drives (SSDs), or the like, or combinations thereof. In some embodiments, the memory element 30 may be embedded in, or packaged in the same package as, the processor 32. The memory element 30 may include, constitute, or embody, a non-transitory “computer-readable medium”. The memory element 30 may store the instructions, code, code statements, code segments, software, firmware, programs, applications, apps, services, daemons, or the like that are executed by the processor 32. The memory element 30 is in electronic communication with the processor 32 and may also store data that is received by the processor 32 or the device in which the processor 32 is implemented. The processor 32 may further store data or intermediate results generated during processing, calculations, and/or computations as well as data or final results after processing, calculations, and/or computations. In addition, the memory element 30 may store settings, lookup tables, text data, documents from word processing software, spreadsheet software and other software applications, sampled audio sound files, photograph or other image data, movie data, databases, and the like.

The processor 32 may comprise one or more processors that include electronic hardware components such as microprocessors (single-core or multi-core), microcontrollers, digital signal processors (DSPs), field-programmable gate arrays (FPGAs), analog and/or digital application-specific integrated circuits (ASICs), intelligence circuitry, or the like, or combinations thereof. The processor 32 may generally execute, process, or run instructions, code, code segments, code statements, software, firmware, programs, applications, apps, processes, services, daemons, or the like. The processor 32 may also include hardware components such as registers, finite-state machines, sequential and combinational logic, configurable logic blocks, and other electronic circuits that can perform the functions necessary for the operation of the current invention. In certain embodiments, the processor 32 may include multiple computational components and functional blocks that are packaged separately but function as a single unit. In some embodiments, the processor 32 may further include multiprocessor architectures, parallel processor architectures, processor clusters, and the like, which provide high performance computing. The processor 32 may be in electronic communication with the other electronic components of the electronic device 10 through serial or parallel links that include universal busses, address busses, data busses, control lines, and the like. In addition, the processor 32 may include analog to digital converters (ADCs) to convert analog electronic signals to digital data values in binary form (such as by sampling), or streams of digital data values, and/or digital to analog converters (DACs) to convert digital data values, or streams of digital data values, to analog electronic signals.

The location determining element 34 generally determines a current geolocation of the electronic device 10 and may receive and process radio frequency (RF) wireless signals, such as wireless location signals, output by satellites of a multi-constellation GNSS such as the global positioning system (GPS) utilized in the United States, the GLONASS system utilized in Russia, the Galileo system utilized in Europe, or the like. The location determining element 34 may include satellite navigation receivers, processors, controllers, other computing devices, or combinations thereof, and memory. The location determining element 34 receives and processes an electronic location signal from the GNSS slot antenna 40 or the GNSS loop antenna 44, which corresponds to, and is derived from, a wireless location signal output by GNSS satellites. The wireless location signal includes data and information that the location determining element 34 is able to utilize to determine a current geolocation of the electronic device 10. An exemplary wireless location signal is output by GPS satellites and has a frequency in the GPS L1 band, which has a center frequency of approximately 1575 MHz. Another exemplary wireless location signal output by GPS satellites has a frequency in the GPS L5 signal, which has a center frequency of approximately 1175 MHz. The location determining element 34 can receive and utilize location signals output by GPS satellites in the GPS L1 band and/or GPS L5 band to determine a current geolocation of the electronic device 10. With the data and information from location signals output by GPS satellites on both the GPS L1 band and the GPS L5 band, the location determining element 34 is configured to determine the current geolocation of the electronic device 10 with greater accuracy than by use of location signals in the GPS L1 band alone. The location determining element 34 may communicate the determined current geolocation to the processor 32, store the determined current geolocation in the memory element 30, or both. Although the location determining element 34 of the current technology utilizes data and information from location signals output by GPS satellites on both GPS L1 and GPS L5 bands, it is within the scope of the current technology for the location determining element 34 to utilize location signals received from other GNSS constellations, such as GLONASS or Galileo. The location determining element 34 is mounted on the printed circuit board 38 within an inner cavity of the housing 12.

The communication element 36 processes a communication electronic signal, electronically communicated between either the communication slot antenna 42 or the communication loop antenna 46 and the communication element 36, that allows the electronic device 10 to communicate with other electronic devices, external systems, networks, such as a Bluetooth™ network and/or a long-term evolution (LTE) cellular network, and the like. The communication element 36 may include signal and/or data transmitting and receiving circuits, such as amplifiers, filters, mixers, oscillators, DSPs, and the like that process RF electronic signals which include data transmitted and received using various communication standards. The communication element 36 processes the communication electronic signal that has a frequency component ranging from approximately 2.40 gigahertz (GHz) to approximately 2.4835 GHz and includes data associated with communication standards such as Bluetooth™, Bluetooth™ low energy (BLE), ANT, ANT+, the industrial, scientific, and medical (ISM) band at 2.4 GHz, or the like. In addition, or instead, the communication electronic signal may include data that is associated with various Institute of Electrical and Electronics Engineers (IEEE) 802.11 Wi-Fi standards operating at 2.4 GHz. In other embodiments, the communication slot antenna 42 or the communication loop antenna 46 and communication element 36 may be utilized to process the communication electronic signal with a frequency component at approximately 860 MHz (MHz) to and includes data associated with communication standards utilized in cellular communications, such as LTE (low band LTE commonly uses frequencies ranging from approximately 600 MHz to approximately 900 MHz, mid band LTE commonly uses frequencies ranging from approximately 1700 to approximately 2200 MHz and high band LTE commonly uses frequencies ranging from approximately 2700 to approximately 3000 MHz). The communication element 36 may decode data that has been received in the communication electronic signal for one or more communication protocols and encode data in the communication electronic signal to be transmitted for one or more communication protocols. The communication element 36 is mounted on the printed circuit board 38.

The printed circuit board 38 retains a plurality of the components of the electronic device 10 and provides electrical connection and electronic communication therebetween. The printed circuit board 38 may be of generally known construction with a first side and an opposing second side. The printed circuit board 38 may also include multiple electrically conductive layers with a top conductive layer placed on the first side, a bottom conductive layer placed on the second side, one or more inner conductive layers positioned between the first and second sides, and an insulating layer between each pair of adjacent conductive layers. The insulating layers may be formed from rigidized or flexible material that includes various combinations of fiberglass, woven glass, matte glass, cotton paper, phenolic cotton paper, polyester, other polymers, epoxies, epoxy resins, and the like. Each electrically conductive layer may include one or more electrically conductive features, such as electronic signal traces, electric power or ground traces, one or more signal, power, or ground pads, integrated circuit package footprints, full or partial power planes, or full or partial ground planes. Also, the electrically conductive features include passive electrical circuit components, such as resistors, capacitors, and inductors. The conductive layers may be formed from metals typically including copper, but also including nickel, aluminum, gold, silver, palladium, zinc, tin, lead, and the like. In addition, the printed circuit board 38 may include plated through hole vias, blind vias, buried vias, and the like. Furthermore, the printed circuit board 38 may include one or more partial or full signal planes and/or one or more signal traces which provide electrical connection, or a signal return path, from the lower housing 52 to the location determining element 34.

The GNSS antenna 40, 44 is configured to receive wireless location signals from GNSS satellites at one or more frequencies, and convert them into one or more corresponding electronic location signals that are conveyed to the location determining element 34. Exemplary embodiments of the GNSS antenna 40, 44 are configured to wirelessly receive GPS L1 band and/or GPS L5 band location signals. Although the GNSS antenna 40, 44 may be implemented as a microstrip antenna, a patch antenna, a linear antenna, an inverted F-antenna, an inverted L-antenna, a dipole antenna, or the like, exemplary embodiments disclosed herein are implemented as a slot antenna (referenced and described herein as the GNSS slot antenna 40) and a loop antenna (referenced and described herein as the GNSS loop antenna 44).

A slot antenna, in its general form, includes an open-centered quadrilateral structure formed from electrically conductive material, such as metals or metal alloys. The slot antenna structure includes an upper conductor, a lower conductor, a left side conductor, and a right side conductor connected to one another to form or create a central opening, or slot. The left side conductor and the right side conductor may be any electrically conductive component, such as a pin, a pogo pin, a spring-loaded contact, a L-shaped washer with a perpendicular contact point, a conductive clamp or similar electrical connector. The electronic signal receiver and/or source is electrically connected to the upper conductor with a signal feed. The lower conductor, the left side conductor, and the right side conductor are electrically connected to an electrical ground (GND). For the GNSS slot antenna 40, the signal feed is electrically coupled with the location determining element 34.

Referring to FIG. 11, an implementation of the upper conductor of the GNSS slot antenna 40 is shown. The upper conductor of the GNSS slot antenna 40 is formed by a first portion of the circumference of the bezel 54. The upper conductor of the GNSS slot antenna 40 has a first endpoint at approximately 3:00 relative to the watch face and extends clockwise to a second endpoint at approximately 9:00 relative to the watch face. Each endpoint is labeled “GND (GNSS)”, as they serve as an electrical ground or common electronic signal path for the GNSS slot antenna 40 that is configured to wirelessly receive the location signal. The upper conductor of the GNSS slot antenna 40 further includes a signal feed point (labeled “SIGNAL FEED (GNSS)”) on a lower surface of the bezel 54 at approximately 7:30 relative to the watch face. The remaining components of the GNSS slot antenna 40 include the lower conductor formed by a first portion of the printed circuit board 38 corresponding to the first portion of the circumference of the bezel 54, the left side conductor formed by a first connector which electrically couples (connects) the bezel 54 to the printed circuit board 38, and the right side conductor formed by a second connector which electrically couples (connects) the bezel 54 to the printed circuit board 38.

A loop antenna, in its general form, includes a loop-shaped conductor connected to a signal feed and an electrical ground. In embodiments, a portion of the bezel 54 and one or more electrically conductive elements, such as pins, pogo pins, spring-loaded contacts, L-shaped washers with a perpendicular contact point, conductive clamps, and similar electrical connectors, form a portion of the GNSS loop antenna 44. For the GNSS loop antenna 44, the signal feed is electrically coupled with the location determining element 34.

Referring to FIG. 12, an implementation of the loop of the GNSS loop antenna 44 is shown. The GNSS loop antenna 44 occupies a first portion of the circumference of the bezel 54 extending in a counterclockwise direction from a signal feed point on a lower surface of the bezel 54 (labeled “SIGNAL FEED (GNSS)”) at approximately 7:30 relative to the watch face to an electrical ground point on a lower surface of the bezel 54 (labeled “GND (GNSS)”) at approximately 3:00 relative to the watch face. Electrically conductive elements, such as pins, pogo pins, spring-loaded contacts, L-shaped washers with a perpendicular contact point, conductive clamps, and similar electrical connectors, connect the signal feed point on a lower surface of the bezel 54 to a signal terminal on the printed circuit board 38 that is electrically coupled (through conductive traces) with the location determining element 34 and the electrical ground point on a lower surface of the bezel 54 to the electrical ground of the printed circuit board 38.

The communication antenna 42, 46 is configured to wirelessly transmit and receive communication signals to and from other electronic devices and/or telecommunication networks. The communication antenna 42, 46 converts to the communication wireless signals to corresponding communication electronic signals and vice versa. The communication antenna 42, 46 may transmit and receive communication wireless signals following protocols such as LTE, Bluetooth™ or Wi-Fi, operating at frequencies including approximately 600 MHz ranging to approximately 900 MHz, approximately 1700 MHz to approximately 2200 MHz, approximately 2.4 GHz, and approximately 2600 MHz to approximately 3000 MHz. Exemplary embodiments of the communication antenna 42, 46 are implemented as a slot antenna (referenced and described herein as the communication slot antenna 42) and as a loop antenna (referenced and described herein as the communication loop antenna 46).

Referring to FIG. 11, an implementation of the upper conductor of the communication slot antenna 42 is shown. The upper conductor of the communication slot antenna 42 is formed by a second portion of the circumference of the bezel 54. The upper conductor of the communication slot antenna 42 has a first endpoint at approximately 9:00 relative to a watch face and extends clockwise to a second endpoint at approximately 1:00 relative to a watch face. The first endpoint is labeled “GND (GNSS, COMMUNICATION)” and the second endpoint is labeled “GND (COMMUNICATION)”, as they serve as an electrical ground or common electronic signal path for the communication slot antenna 42 that is configured to wirelessly receive the communication electronic signal. The upper conductor of the communication slot antenna 42 further includes a signal feed point (labeled “SIGNAL FEED (COMMUNICATION)”) on a lower surface of the bezel 54 at approximately 9:30 relative to the watch face. The remaining components of the communication slot antenna 42 include the lower conductor formed by a second portion of the printed circuit board 38 corresponding to the second portion of the circumference of the bezel 45, the left side conductor formed by the first connector (shared with the GNSS slot antenna 40) which electrically couples (connects) the bezel 54 to the printed circuit board 38, and the right side conductor formed by a third connector which electrically couples (connects) the bezel 54 to the printed circuit board 38.

Referring to FIG. 12, an implementation of the loop of the communication loop antenna 46 is shown. The communication loop antenna 46 occupies a second portion of the circumference of the bezel 54 extending in a counterclockwise direction from a signal feed point on a lower surface of the bezel 54 (labeled “SIGNAL FEED (COMMUNICATION)”) at approximately 10:00 relative to the watch face to an electrical ground point on a lower surface of the bezel 54 (labeled “GND (COMMUNICATION)”) at approximately 1:00 relative to the watch face. Electrically conductive elements, such as pins, pogo pins, spring-loaded contacts, L-shaped washers with a perpendicular contact point, conductive clamps, and similar electrical connectors, connect the signal feed point on a lower surface of the bezel 54 to a signal terminal on the printed circuit board 38 that is electrically coupled (through conductive traces) with the communication element 36 and the electrical ground point on a lower surface of the bezel 54 to the electrical ground of the printed circuit board 38.

The GNSS slot antenna 40 and the communication slot antenna 42 each radiate with a wireless RF radiating pattern that is aligned with, and originates from, the slot (central opening) of the GNSS slot antenna 40 and the communication slot antenna 42, respectively. For exemplary embodiments of the GNSS slot antenna 40, the slot is vertically positioned between the lower surface of bezel 54 and the printed circuit board 38, such that the slot is aligned with the perimeter of the first portion of bezel 54 and the first portion of the perimeter of the printed circuit board 38, which are substantially shaped to fit over or within the side wall 62 of the receiving structure 56 of the housing 12. Similarly, for exemplary embodiments of the communication slot antenna 42, the slot is vertically positioned between the lower surface of bezel 54 and the printed circuit board 38, such that the slot is aligned with the perimeter of the second portion of bezel 54 and the second portion of the perimeter of the printed circuit board 38, which are substantially shaped to fit over or within the side wall 62 of the receiving structure 56 of the housing 12. Thus, the GNSS slot antenna 40 and the communication slot antenna 42 generally radiate through the side wall 62, which is formed of a electrically non-conductive material. Accordingly, as shown in FIG. 11, the GNSS slot antenna 40 may radiate through the side wall 62 in a lower portion of the housing 12, including the 6:00 position, and the communication slot antenna 42 may radiate through the side wall 62 in an upper portion of the housing 12, including the 12:00 position.

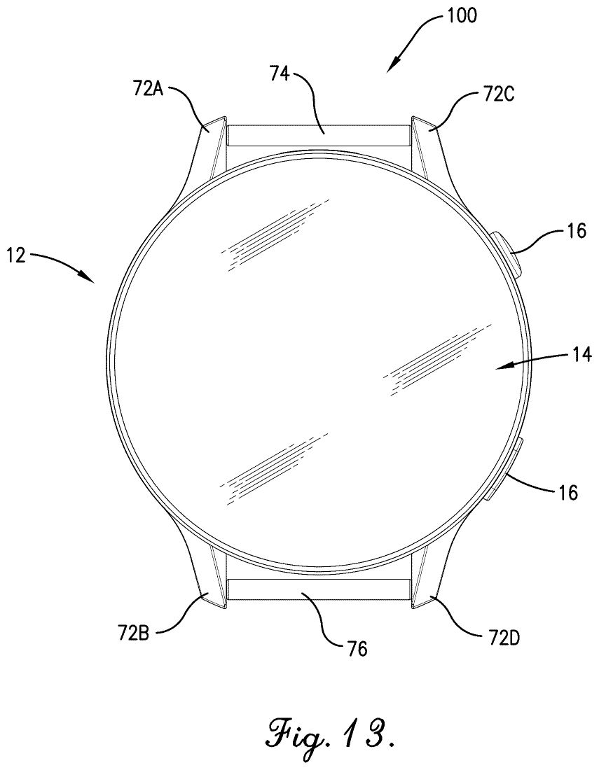

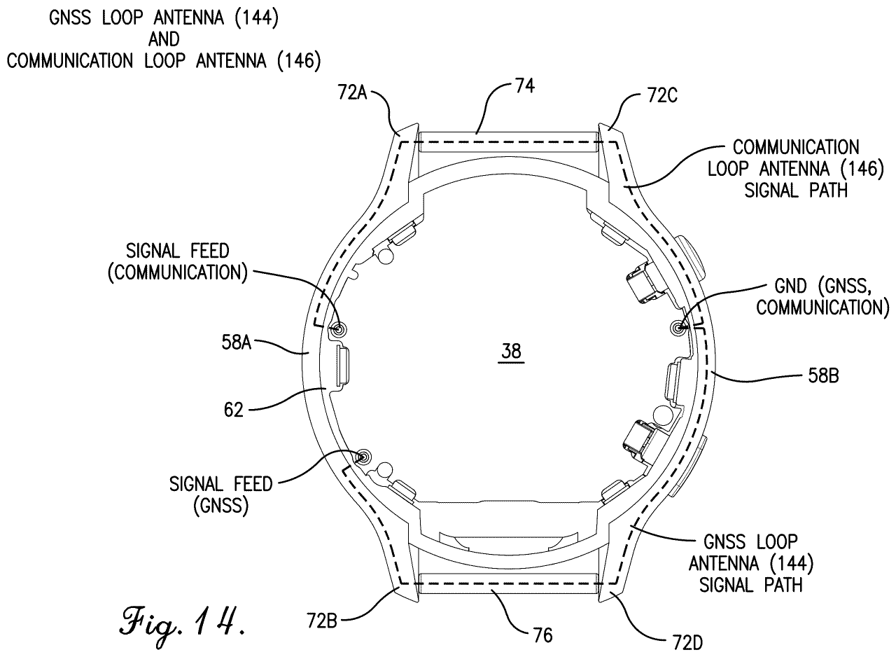

Referring to FIGS. 13 and 14, another embodiment of the wrist-worn electronic device 100 is illustrated. The electronic device 100 is substantially similar to the electronic device 10, except that the electronic device 100 does not include the bezel 54, the GNSS slot antenna 40 or the communication slot antenna 42. The display 14 of the electronic device 100 extends to the side wall 62 of the receiving structure 56 of the housing 12. In embodiments, display 14 includes a cover (typically formed from glass) that is positioned at the outermost layer of the elements forming display 14.

In addition, a GNSS loop antenna 144 and a communication loop antenna 146 are implemented in a different fashion from the GNSS loop antenna 44 and the communication loop antenna 46, respectively. The loop portion of the loop antennas, which also forms at least part of the electronic signal path, utilizes electrically-conductive components including one or more portions of the first outer structural element 58A and one or more portions of the second outer structural element 58B as well as the first wrist band pin 74 and the second wrist band pin 76. The first wrist band pin 74 and the second wrist band pin 76 are formed of an electrically conductive material, such as metal.

With reference to FIG. 14, the signal paths for the GNSS loop antenna 144 and the communication loop antenna 146 are shown. The signal path for the GNSS loop antenna 144 includes a signal feed “SIGNAL FEED (GNSS)” connection between the first outer structural element 58A and the printed circuit board 38 at approximately 8:00 relative to the watch face. The signal passes through an opening of the side wall 62 to electrically connect a terminal that is electrically coupled to the location determining element 34 with the first outer structural element 58A. The signal path of the GNSS loop antenna 144 extends in a counterclockwise direction from approximately 8:00 relative to the watch face, along the first outer structural element 58A, through the second lug 72B, the second wrist band pin 76, and the fourth lug 72D, to the second outer structural element 58B that has an electrical ground connection labeled “GND (GNSS, COMMUNICATION)” at approximately 3:00 relative to the watch face, where the signal path of the GNSS loop antenna 144 passes through an opening in the side wall 62 to an electronic ground connection of the printed circuit board 38. Accordingly, the signal path of the GNSS loop antenna 144 extends through the second wrist band pin 76 to pass in a counterclockwise direction from approximately 8:00 to 3:00 relative to the watch face.

Similarly, the signal path for the communication loop antenna 146 includes a signal feed “SIGNAL FEED (COMMUNICATION)” connection between the first outer structural element 58A and the printed circuit board 38 at approximately 9:00 relative to the watch face. The signal passes through an opening of the side wall 62 to electrically connect a terminal that is electrically coupled to the communication element 36 with the first outer structural element 58A. The signal path of the communication loop antenna 146 extends in a clockwise direction from approximately 9:00 relative to the watch face, along the first outer structural element 58A, through the first lug 72A, the first wrist band pin 74, and the third lug 72C, to the second outer structural element 58B having the electrical ground connection labeled “GND (GNSS, COMMUNICATION)” at approximately 3:00 relative to the watch face, where the signal path of the communication loop antenna 146 passes through the side wall 62 to the electronic ground connection of (shared with the GNSS loop antenna 144) the printed circuit board 38. Accordingly, the signal path of the communication loop antenna 146 extends through the first wrist band pin 74 to pass in a clockwise direction from approximately 9:00 to 3:00 relative to the watch face.

However, it is to be understood that in other embodiments the signal path of the GNSS loop antenna 144 may extend in a clockwise direction by positioning the signal feed “SIGNAL FEED (GNSS)” connection between the first outer structural element 58A and the printed circuit board 38 at approximately 3:00 relative to the watch face and positioning the electrical ground connection labeled “GND (GNSS, COMMUNICATION)” at approximately 8:00 relative to the watch face. Similarly, the signal path of the communication loop antenna 146 may extend in a counterclockwise direction by positioning the signal feed “SIGNAL FEED (COMMUNICATION)” connection between the first outer structural element 58A and the printed circuit board 38 at approximately 3:00 relative to the watch face and positioning the electrical ground connection labeled “GND (GNSS, COMMUNICATION)” at approximately 9:00 relative to the watch face. In such embodiments, the receiving structure 56 and other electrically conductive elements of the housing 12 electrically ground the first outer structural element 58A between 8:00 and 9:00 relative to the watch face.

In embodiments, the portion of the first outer structural element 58A between the “SIGNAL FEED (GNSS)” and the “SIGNAL FEED (COMMUNICATION)” points (extending in a clockwise direction from approximately 8:00 to 9:00 relative to the watch face) is electrically grounded to electrically isolate the signal path of the GNSS loop antenna 144 from the signal path of the communication loop antenna 146. A plurality of electrical connections may be made between that portion of the first outer structural element 58A and the electrical ground of the printed circuit board 38.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A wrist-worn electronic device comprising:
an upper housing including a bezel formed from electrically conductive material; and
a lower housing including:
a receiving structure formed from electrically non-conductive material, the receiving structure including
a bottom wall, and
one or more side walls connected to the bottom wall, the one or more side walls having within an outer surface thereof a first recess and a second recess, the second recess at a position opposing the first recess, and
at least two outer structure elements formed from electrically conductive material, each outer structure element positioned in and secured to a respective one of the first recess and the second recess.

2. The wrist-worn electronic device of claim 1, wherein the at least two outer structure elements include
a first outer structure element positioned on a first side of the receiving structure, the first outer structure element including a first end forming a first lug of the lower housing and a second, opposing end forming a second lug of the lower housing, and
a second outer structure element positioned on a second, opposing side of the receiving structure, the second outer structure element including a first end forming a third lug of the lower housing and a second, opposing end forming a fourth lug of the lower housing.

3. The wrist-worn electronic device of claim 2, wherein the first lug and the third lug retain a first wrist band pin secured therebetween, and the second lug and the fourth lug retain a second wrist band pin secured therebetween.

4. The wrist-worn electronic device of claim 2, further comprising a user interface component, wherein the first outer structure element includes an opening through which at least a portion of the user interface component passes to an inner cavity formed by the upper housing and the lower housing.

5. The wrist-worn electronic device of claim 1, further comprising a plurality of fasteners configured to attach the outer structure elements to the one or more side walls.

6. The wrist-worn electronic device of claim 1, wherein a bottom surface of the bezel and an upper surface of the at least two outer structure elements are separated by a first separation distance.

7. The wrist-worn electronic device of claim 1, further comprising a display, wherein the bezel includes a central opening within which the display is positioned and visible.

8. The wrist-worn electronic device of claim 1, further comprising a light source configured to output light, wherein the one or more side walls of the receiving structure include a first opening through which the light passes from the light source out of the lower housing.

9. The wrist-worn electronic device of claim 8, further comprising a microphone configured to receive audible signals, wherein the one or more side walls of the receiving structure include a second opening through which the audible signals pass to the microphone.

10. The wrist-worn electronic device of claim 9, further comprising a barometric pressure measurement device configured to determine an atmospheric pressure proximate to the lower housing, wherein the one or more side walls of the receiving structure include a third opening through which air passes to the barometric pressure measurement device.

11. The wrist-worn electronic device of claim 1, further comprising a plurality of optical transmitters that output optical signals and a plurality of optical receivers that receive reflections of the optical signals, wherein the bottom wall of the receiving structure includes a first opening through which the optical signals are output by the plurality of optical transmitters and reflections of the optical signals are received by the plurality of optical receivers.

12. The wrist-worn electronic device of claim 11, further comprising an electrical interface configured to electrically couple with a cable, wherein the bottom wall includes a second opening through which at least a portion of the cable passes to electrically couple with the electrical interface.

13. A wrist-worn electronic device comprising:
an upper housing including a bezel formed from electrically conductive material; and
a lower housing including:
a receiving structure formed from electrically non-conductive material, the receiving structure including
a bottom wall, and
a side wall connected to the bottom wall, the side wall having within an outer surface thereof a first recess and a second recess, the second recess at a position opposing the first recess;
a first outer structure element formed from electrically conductive material and positioned in the first recess, the first outer structure element including an upper surface that is spaced apart from a lower surface of the bezel by a first separation distance; and
a second outer structure element formed from electrically conductive material and positioned in the second recess, the second outer structure element including an upper surface that is spaced apart from the lower surface of the bezel by the first separation distance.

14. The wrist-worn electronic device of claim 13, wherein
the first outer structure element including a first end forming a first lug of the lower housing and a second, opposing end forming a second lug, and
the second outer structure element including a first end forming a third lug of the lower housing and a second, opposing end forming a fourth lug.

15. The wrist-worn electronic device of claim 14, wherein the first lug and the third lug retain a first wrist band pin secured therebetween, and the second lug and the fourth lug retain a second wrist band pin secured therebetween.

16. The wrist-worn electronic device of claim 13, further comprising a plurality of fasteners configured to attach the first outer structure element and the second outer structure element to the side wall.

17. The wrist-worn electronic device of claim 13, wherein at least one of the first outer structure element and the second outer structure element includes at least one opening through which at least one component of a user interface is positioned.

18. The wrist-worn electronic device of claim 13, wherein the side wall includes one or more openings through which one or more of a light source, a microphone, and a barometric pressure measurement device are accessed.

19. A wrist-worn electronic device comprising:
an upper housing including a bezel formed from electrically conductive material; and
a lower housing including:
a receiving structure formed from electrically non-conductive material, the receiving structure including
a bottom wall, and
a side wall connected to the bottom wall, the side wall having within an outer surface thereof a first recess and a second recess, the second recess at a position opposing the first recess;
a first outer structure element formed from electrically conductive material and positioned in the first recess, the first outer structure element including a first end forming a first lug and a second, opposing end forming a second lug;
a second outer structure element formed from electrically conductive material and positioned in the second recess, the second outer structure element including a first end forming a third lug and a second, opposing end forming a fourth lug;
a plurality of fasteners configured to attach the first outer structure element and the second outer structure element to the side wall;
a first wrist band pin secured between the first lug and the third lug; and
a second wrist band pin secured between the second lug and the fourth lug.

20. The wrist-worn electronic device of claim 19, wherein at least one of the first outer structure element and the second outer structure element includes at least one opening through which at least one component of a user interface is positioned.
